(19) United States
(12) Patent Application Publication
(10) Pub. No.: US 2018/0007212 A1
(43) Pub. Date: Jan. 4, 2018

(54) DIFFERENTIAL CHARGING FOR LICENSED AND UNLICENSED SPECTRUM USAGE

(71) Applicant: Intel Corporation, Santa Clara, CA (US)

(72) Inventors: ALEXANDER SIROTKIN, Petach Tikva, M (IL); JING ZHU, Portland, OR (US); NAGEEN HIMAYAT, Fremont, CA (US)

(73) Assignee: Intel Corporation, Santa Clara, CA (US)

(21) Appl. No.: 15/544,871

(22) PCT Filed: Jun. 26, 2015
(86) PCT No.: PCT/US15/38098

§ 371 Date: Jul. 19, 2017

Related U.S. Application Data
(60) Provisional application No. 62/117,374, filed on Feb. 17, 2015.

(51) Int. Cl. H04M 15/00; H04W 4/24

(52) U.S. Cl. CPC H04M 15/60; H04W 4/24; H04M 15/50; H04M 15/64; H04M 15/65

(57) ABSTRACT

Embodiments of the present disclosure describe systems, devices, and methods for charging architectures in cellular networks. Various embodiments may include an eNB collecting information about licensed and unlicensed spectrum resource usage on a per bearer basis and transmitting the information to a core network node. Other embodiments may be described or claimed.

### CROSS-REFERENCE TO RELATED APPLICATION

This application claims the benefit of U.S. Provisional Application No. 62/117,374 filed Feb. 17, 2015, entitled “CHARGING ARCHITECTURE FOR LTE/WLAN AGGREGATION AND LTE-U,” the entirety of which is hereby incorporated herein by reference.

### FIELD

Embodiments of the present disclosure generally relate to the field of wireless communication, and more particularly, to methods and apparatuses for charging architectures for wireless networks.

### BACKGROUND

It is expected that in Release 13 (Rel-13), Third Generation Partnership Project (3GPP) will define two new processes for using unlicensed spectrum: Long Term Evolution-Unlicensed (LTE-U/License Assisted Access (LAA) and Long Term Evolution (LTE/Wireless Local Area Network (WLAN) aggregation. In both technologies, the usage of unlicensed spectrum is transparent to the evolved packet core (EPC), which is one of the biggest advantages of these technologies. However, given current architectures, charging differently for licensed and unlicensed spectrum usage may be difficult.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a charging architecture in accordance with various embodiments.

FIG. 2 illustrates another charging architecture in accordance with various embodiments.

FIG. 3 illustrates another charging architecture in accordance with various embodiments.

FIG. 4 illustrates an electronic device in accordance with various embodiments.

FIG. 5 illustrates a reporting procedure in accordance with some embodiments.

### DETAILED DESCRIPTION

Illustrative embodiments of the present disclosure include, but are not limited to, methods, systems, computer-readable media, and apparatuses for charging architectures in cellular networks.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc., in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well-known devices, circuits, and methods are omitted so as not to obscure the description of the present invention with unnecessary detail.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in some embodiments” is used repeatedly. The phrase generally does not refer to the same embodiments; however, it may. The terms “comprising,” “having,” and “including” are synonymous, unless the context dictates otherwise.

The phrases “A or B,” “A/B,” and “A and/or B” mean (A), (B), or (A and B).

As used herein, the term “circuitry” refers to, is part of, or includes hardware components such as an Application Specific Integrated Circuit (ASIC), an electronic circuit, a logic circuit, a processor (shared, dedicated, or group) and/or memory (shared, dedicated, or group) that are configured to provide the described functionality. In some embodiments, the circuitry may execute one or more software or firmware programs to provide at least some of the described functionality.

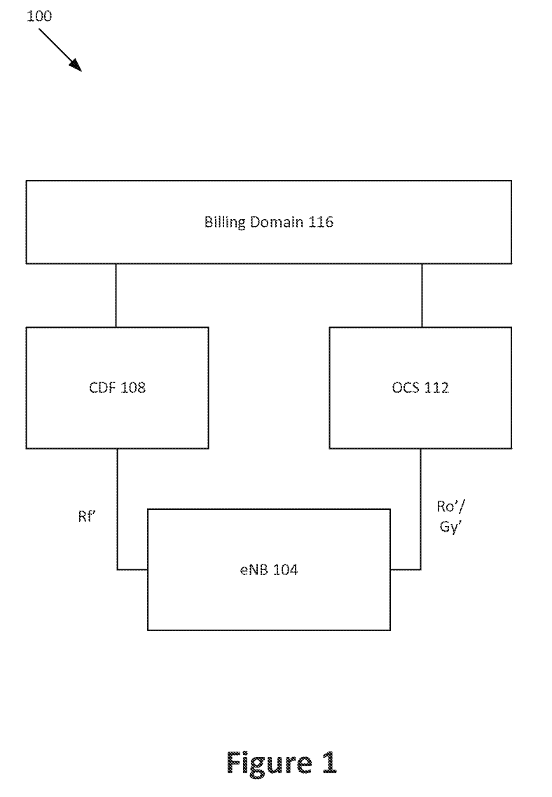

FIG. 1 schematically illustrates a charging architecture 100 in accordance with various embodiments. The charging architecture 100 includes an evolved node B (eNB) 104 coupled with a charging data function (CDF) 108 and an online charging system (OCS) 112. The CDF 108 and the OCS 112 may be coupled with a billing domain 116. The eNB 104, CDF 108, and OCS 112 may be part of a cellular network such as a 3GPP LTE Advanced (LTE-A) network. The eNB 104 may be in a radio access network (RAN) portion of the LTE-A network and the CDF 108 and OCS 112 may be in a core network (CN) portion of the LTE-A network. In other embodiments, other network technologies may be utilized.

In general, the CDF 108 may be a logical charging function to provide offline charging procedures. The CDF 108 may provide offline charging procedures by collecting charging information for network resource usage by a user equipment (UE) concurrently with the resource usage by the UE. The CDF 108 may generate a charging data record (CDR) file that includes details about the resource usage by the UE. The CDF 108 may report the CDR file to the billing domain 116 after the resource usage has occurred. Thus, offline charging is a mechanism in which the charging information does not affect, in real-time, the service rendered.

The OCS 112 may include a logical charging function to provide online charging procedures. The OCS 112 may collect charging information for network resource usage concurrently with the resource usage and generate and report the CDR file in a manner similar to the CDF 108. However, unlike the CDF 108, the OCS 112 may provide an authorization for network resource usage prior to the occurrence of the actual resource usage. The authorization may be granted by the OCS 112 upon request from the network, for example, from the eNB 104.

The OCS 112 may include a number of components to facilitate online charging procedures. These components may include, but are not limited to, an online charging function (OCF) that includes a session-based charging function and an event-based charging function; a charging gateway function; and a rating function. The components of the OCS 112 may be similar to those described in 3GPP Technical Specification (TS) 32.296 v12.3.0 (2014-12).

The billing domain 116 may receive CDR files from the CDF 108 or the OCS 112 for purposes of subscriber billing, inter-operator accounting, or other types of statistical analysis or use. The billing domain 116 may include an operator's billing system or mediation device.

With the exception of the differences noted herein, the CDF 108, OCS 112, and the billing domain 116 may operate consistently with descriptions provided in 3GPP TS 32.240, v12.6.0 (2014-12) and related TSs, for example, TS 32.296.

Various charging scenarios may be implemented by an operator through the billing domain. In the simplest scenario, an operator may not make a distinction on whether traffic corresponding to a particular bearer is transported over licensed or unlicensed spectrum (using the additional spectrum to augment the capacity of their deployment in a manner transparent to a user). On the other extreme, the operator may allow all use of unlicensed traffic to be free of charge. More generally, the operator may apply, or wish to apply, different charging rates or authorizations for licensed and unlicensed spectrum usage. Differentiated service may require the usage across different radio access technologies (RATs) to be tracked separately within a charging architecture.

A bearer, as used herein, may be a link between two points, which is defined by a certain set of characteristics, for example, quality of service attributes. The bearer may be an evolved packet system (EPS) bearer between, for example, a UE and a packet gateway (P-GW), or some other type of bearer. Bearers may provide access to a cellular network using one or more RATs.

Unlicensed spectrum or licensed-exempt spectrum, as used herein, refers to portions of a radio spectrum that users can access for wireless services without an explicit license from a regulatory authority such as, but not limited to, Federal Communications Commission (FCC). Licensed spectrum, as used herein, refers to portions of the radio spectrum that are licensed, exclusively or non-exclusively, to a licensee by a regulatory authority such as, but not limited to, the FCC. The licensed spectrum may allow a licensee use of particular frequencies or channels in particular locations for commercial services.

To facilitate the application of different charging rates or authorizations for licensed and unlicensed spectrum usage, the operator may need to know how much traffic was delivered (or received) on a per user/per bearer level using licensed and unlicensed spectrum. This information may be relevant for both online and offline charging scenarios. In the online charging scenario, the operator may also want the network to obtain authorization (on per bearer/per user basis) for licensed and unlicensed spectrum usage.

To facilitate differential charging of traffic going on licensed and unlicensed spectrum, embodiments of the present disclosure include the eNB 104 directly interfacing with the CDF 108 and the OCS 112 as shown in FIG. 1. In particular, the eNB 104 may interface with the CDF 108 via an Rf interface to exchange offline charging information; and may interface with the OCS 112 via an Ro′/Gy′ interface to exchange online charging information.

Communication over the Rf′, Ro′, and Gy′ interfaces (also referred to as “reference points” in some embodiments) may be performed with respect to corresponding Rf′, Ro′, and Gy′ protocols. The Rf′, Ro′, and Gy′ interfaces/protocols may be similar to respective Rf, Ro, and Gy interfaces/protocols described in TS 32.240 and related TSs (e.g., 3GPP TS 32.299 v12.7.0 (2014-12)), with the exception that the Rf′ interface is between the eNB 104 and the CDF 108 and the Ro′/Gy′ interfaces are between the eNB 104 and the OCS 112.

Briefly, the Rf′ interface may support provision of information related to charging events for offline charging from the eNB 104 to the CDF 108 and may further support acknowledgments for these events from the CDF 108 to the eNB 104. Information related to charging events may also be referred to as charging information. The Rf′ protocol crossing the Rf′ interface may support real-time transactions, stateless mode (for example, event-based charging) and stateful mode (for example, session-based charging) of operation; and may further provide its own reliability mechanism, for example, retransmission of charging events, to facilitate transmission over unreliable transports.

The Ro′ interface may support provision of information related to charging events for online charging from the eNB 104 to the OCS 112 and may further support acknowledgments for these events from the OCS 112 to the eNB 104. The acknowledgment may grant or reject a network resource usage that is requested in the charging event according to a decision taken by the OCS 112. The Ro′ protocol crossing the Ro′ interface may support real-time transactions, stateless mode (for example, event-based charging) and stateful mode (for example, session-based charging) of operation; and may further provide its own reliability mechanism, for example, retransmission of charging events, to facilitate transmission over unreliable transports.

The Gy′ interface may be similar to the Ro′ interface.

Offline charging information transferred via the Rf′ interface may include amounts of traffic per bearer delivered via licensed and unlicensed spectrum. In order for the charging system to correlate this information with information received from other network nodes (for example, a packet gateway (P-GW) and a serving gateway (S-GW)), the charging information may further include bearer identifiers. In some embodiments, offline charging information may further include a bearer offload time (for example, how long, for example, in seconds, a bearer has been offloaded to an unlicensed band since the last reporting); downlink bearer offload volume (for example, how much load, for example, in kilobytes, of a bearer has been offloaded to unlicensed band in the downlink since the last reporting); uplink bearer offload volume (for example, how much load, for example, in kilobytes, of the EPS bearer has been offloaded to unlicensed band on the uplink since the last reporting); and policies governing the use of licensed and unlicensed bands.

Online charging information transferred via the Ro′/Gy′ interface may include information similar to the offline charging information transferred via the Rf′ interface. The online charging information transferred via the Ro′/Gy′ interface may further include a request, from the eNB 104, for authorization to use licensed or unlicensed spectrum on per bearer/per user level. This authorization request may be done when the bearer is established or periodically.

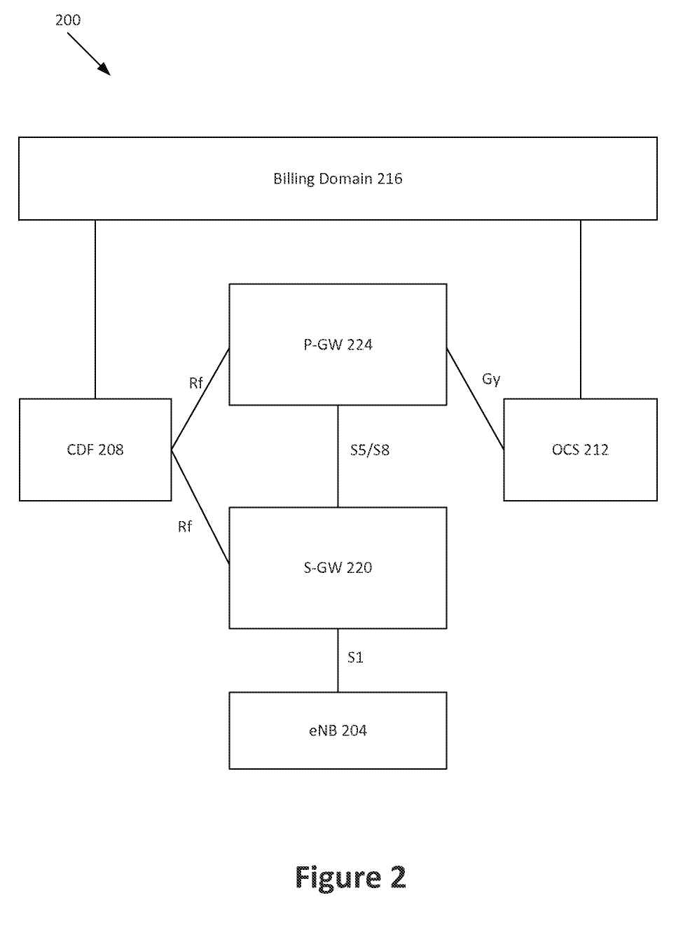

FIG. 2 schematically illustrates another charging architecture 200 in accordance with various embodiments. The charging architecture 200 may include an eNB 204, CDF 208, OCS 212, and billing domain 216 that are similar to like-named elements discussed above with respect to FIG. 1, except as otherwise noted. FIG. 2 further shows S-GW 220 and P-GW 224. Briefly, the S-GW 220 may be responsible for handovers with neighboring eNBs and for data transfer in terms of packets across a user plane; and the P-GW 224 may be responsible to act as an anchor mobility between 3GPP and non-3GPP technologies.

The CDF 208 may communicate with S-GW 220 and P-GW 224 via Rf interfaces; OCS 212 may communicate with P-GW 224 via a Gy interface; P-GW 224 may communicate with S-GW 220 via an S5/S8 interface; and S-GW 220 may communicate with eNB 204 via an S1 interface. These interfaces may be similar to those described in existing TSs, for example, TS 32.240 and 3GPP TS 23.401 v13.1.0 (2014-12). However, some of these interfaces are updated to carry charging information to allow the charging architecture 200 to provide differential charging of traffic going on licensed and unlicensed spectrum as described below.

In some embodiments, the S1-AP protocol used on the S1 interface may be enhanced to communicate offline and online charging information, such as that described above, from the eNB 204 to the S-GW 220. The S-GW 220 may relay this charging information to the CDF 208. Alternatively, the S-GW 220 may pass the charging information to the P-GW 224 using an S5/S8 interface that is enhanced to convey such information. The P-GW 224 may then communicate the charging information to the CDF 208 via the Rf interface or to the OCS 212 via the Gy interface.

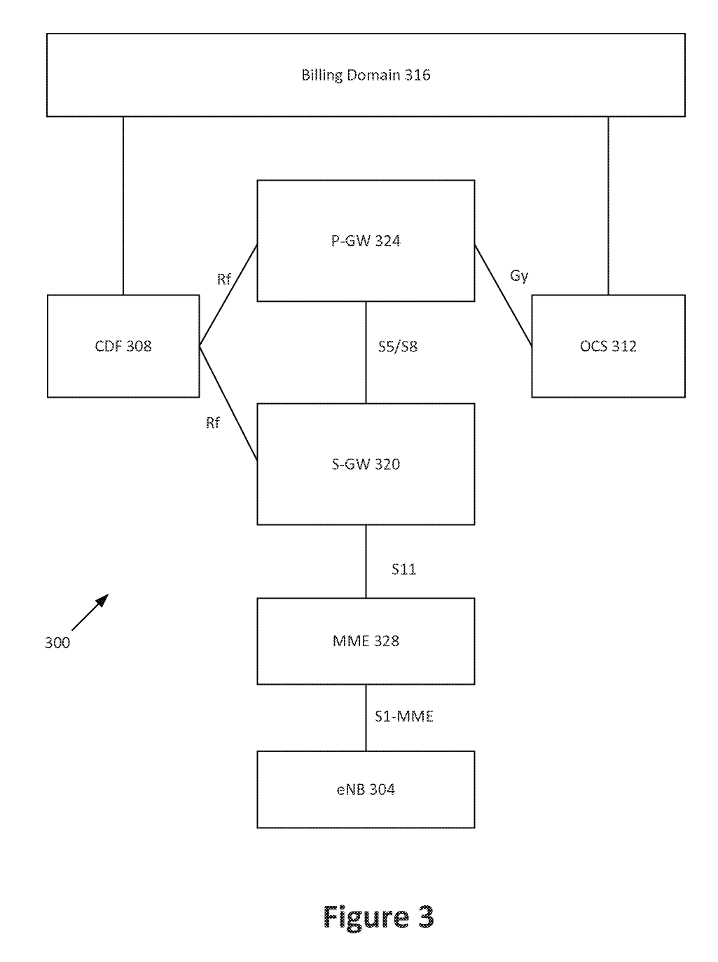

FIG. 3 schematically illustrates another charging architecture 300 in accordance with various embodiments. The charging architecture 300 may include an eNB 304, CDF 308, OCS 312, billing domain 316, S-GW 320, and P-GW 324 that are similar to like-named elements discussed above with respect to FIG. 1 or 2, except as otherwise noted. The charging architecture 300 further includes a mobility management entity (MME) 328. Briefly, the MME 328 may be responsible for tracking and paging procedures with respect to the UE. The MME 328 may also be involved in bearer activation/deactivation.

In addition to the interfaces shown and discussed above with respect to FIG. 2, the charging architecture 300 includes an S11 interface by which the S-GW 320 and the MME 328 may communicate; and an S1-MME interface by which the MME 328 and the eNB 304 may communicate. These interfaces may be similar to those described in existing TSs, for example, TS 32.240 and 3GPP TS 23.401. However, some of these interfaces are updated to carry charging information to allow the charging architecture 300 to provide differential charging of traffic going on licensed and unlicensed spectrum as described below.

In particular, the S1-MME interface may be enhanced to carry charging information, such as that described above, between the eNB 304 and the MME 328; and the S11 interface may be enhanced to carry the charging information between the S-GW 320 and the MME 328.

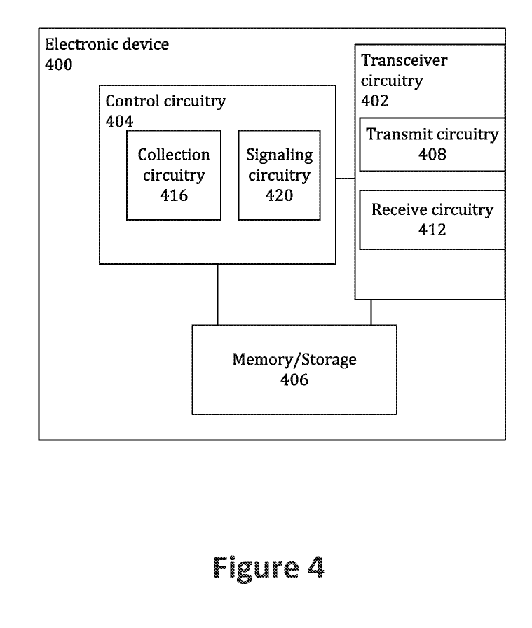

FIG. 4 illustrates an electronic device 400 in accordance with some embodiments. The electronic device 400 may be an eNB, S-GW, P-GW, MME, CDF, or OCS as described elsewhere in the present disclosure. In embodiments, the electronic device 400 may include transceiver circuitry 402, control circuitry 404, and memory/storage 406 coupled with one another at least as shown. The transceiver circuitry 402 may include both transmit circuitry 408 and receive circuitry 412. The control circuitry 404 may include collection circuitry 416, which may also be referred to as statistics circuitry, and signaling circuitry 420.

The transceiver circuitry 402 or control circuitry 404 may be suitably configured with hardware, software, or firmware to perform the operation described with respect to devices discussed herein. In particular, the transceiver circuitry 402 or control circuitry 404 may include one or more single-core or multi-core processors coupled with memory-storage and configured to execute instructions stored in the memory-storage to enable various applications or operating systems to run on the system. The processors may include any combination of general-purpose processors or dedicated processors, for example, communication processors (for example, baseband processors), application processors, digital signal processors, etc.

The memory/storage 406 may be used to load and store data or instructions for the electronic device 400. Memory/storage for one embodiment may include any combination of suitable volatile memory (e.g., dynamic random access memory (DRAM)) and/or non-volatile memory (e.g., Flash memory).

In general, the collection circuitry 416 may be configured to perform higher-layer operations related to the collection, reporting, and processing of the charging information; the signaling circuitry 420 may be configured for generating and processing signals according to parameters associated with relative interfaces/protocols; and the transceiver circuitry 402 may be configured for providing the transmission/reception of the signals over the appropriate interfaces.

In embodiments in which the electronic device 400 is an eNB, the signaling circuitry 420 may include baseband circuitry to handle various radio control functions (e.g., signal modulation/demodulation, encoding/decoding, etc.) that enable communication with one or more radio networks via the transceiver circuitry 402, which may include circuitry for the radio-frequency (RF) communications. In such embodiments, the transceiver circuitry 402 may include RF circuitry such as switches, filters, amplifiers, etc. to facilitate communication with the wireless network via one or more antennas. The RF communications may take place using, for example, a plurality of RATs. The RF communications may involve the provision of radio resources to UEs in both licensed and unlicensed bands. For example, the RF communications may involve WLAN/LTE aggregation communications, LTE-U/LAA communications, etc.

In addition to having circuitry for radio-frequency communications, when the electronic device 400 is an eNB, the signaling circuitry 420 and transceiver circuitry 402 may include circuitry for communication over other wired or wireless communication interfaces. For example, the signaling circuitry 420 and transceiver circuitry 402 may include circuitry to communicate over an Rf′ interface with a CDF and circuitry to communicate over an Ro′/Gy′ interface with an OCS such as that described in FIG. 1. In some embodiments, the signaling circuitry 420 and transceiver circuitry 402 may include circuitry to communicate over an S1 interface with an S-GW such as described in FIG. 2; or circuitry to communicate over an S1-MME interface with an MME such as described in FIG. 3.

In embodiments in which the electronic device 400 is a CDF, the signaling circuitry 420 and transceiver circuitry 402 may include circuitry for communication over an Rf′ interface with an eNB such as that described in FIG. 1; or circuitry to communicate over an Rf interface with S-GW or P-GW as described in FIG. 2 or 3.

In embodiments in which the electronic device 400 is an OCS, the signaling circuitry 420 and transceiver circuitry 402 may include circuitry for communication over an Ro′/Gy′ interface with an eNB as described in FIG. 1; or circuitry to communicate over a Gy interface with a P-GW as described in FIG. 2 or 3.

In embodiments in which electronic device 400 is an S-GW, the signaling circuitry 420 and transceiver circuitry 402 may include circuitry for communication over an Si interface with an eNB, an Rf interface with a CDF, or an S5/S8 interface with P-GW as described in FIG. 2; or circuitry for communication over an S11 interface with an MME, an Rf interface with a CDF, or an S5/S8 interface with P-GW as described in FIG. 3.

In embodiments in which electronic device 400 is a P-GW, the signaling circuitry 420 and transceiver circuitry 402 may include circuitry for communication over an S5/S8 interface with an S-GW, an Rf interface for communication with a CDF, or a Gy interface for communication with an OCS as described in FIG. 2 or 3.

In embodiments in which the electronic device 400 is an eNB, the control circuitry 404, and the collection circuitry 416, in particular, may identify, collect, and report charging information related to licensed spectrum resource usage and unlicensed spectrum resource usage related to one or more bearers in a wireless network from the perspective of the eNB as described herein. This may include, but is not limited to, measuring traffic over licensed and unlicensed spectrum, generating reports, detecting reporting triggers, and sending report through components of a charging architecture.

In embodiments in which the electronic device 400 is a CDF or an OCS, the collection circuitry 416 may control collection and reporting of charging information from the perspective of the respective CDF/OCS. This may include, but is not limited to, receiving and responding to authorization requests (for example, in an online charging scenario); receiving reports from an eNB or other components of a charging architecture; requesting reports from the eNB; generating a CDR; or transmitting the CDR to the billing domain to facilitate billing functions.

The control circuitry 404 may be included in or implemented by a chip, chipset, or other collection of programmed or preconfigured circuitry. Similarly, the transceiver circuitry 402 may be included in and/or implemented by a chip, chipset, or other collection of programmed or preconfigured circuitry. In various embodiments, some or all of the transceiver circuitry 402 and control circuitry 404 may be incorporated in a common chip, chipset, or other collection of programmed or preconfigured circuitry.

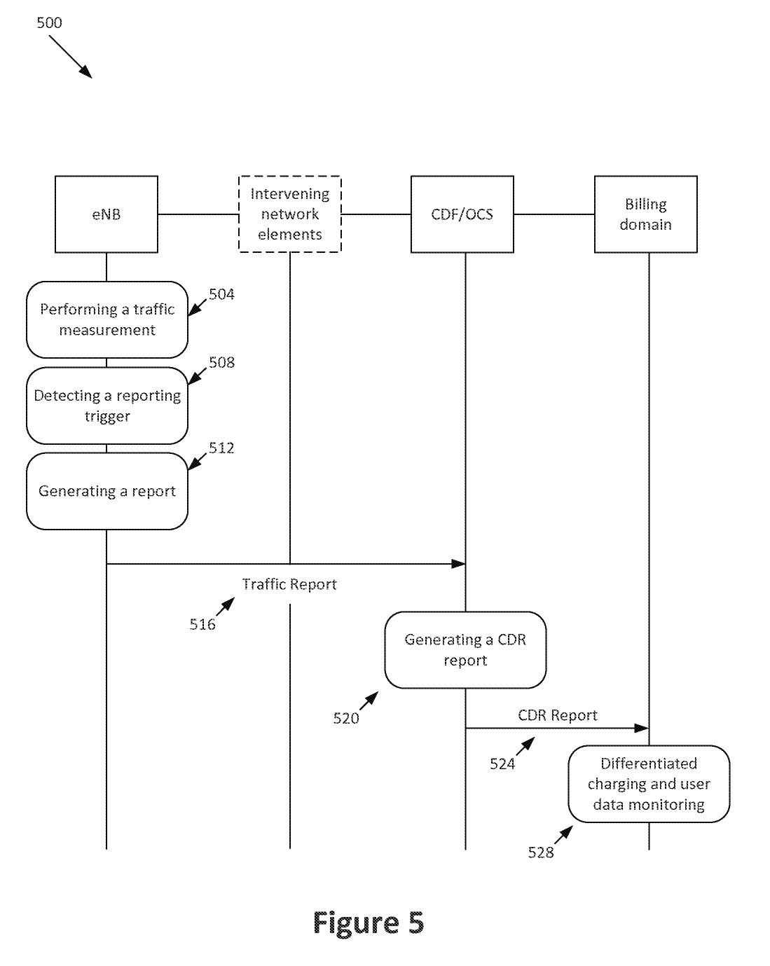

FIG. 5 illustrates a flowchart that describes a reporting procedure 500 in accordance with some embodiments. In some embodiments, the operations described with respect to the reporting procedure 500 may be performed by components of an electronic device such as that described above with respect to FIG. 4. The reporting procedure 500 may equally apply to LTE-U/LAA and LTE/WLAN aggregation technologies, even though these may be very different on an access stratum level.

At 504, the reporting procedure 500 may include an eNB performing a traffic measurement to determine various charging information. The charging information may be similar to that described above. The traffic measurement may be performed by collection circuitry in the eNB such as that described above with respect to FIG. 4. The collection circuitry may monitor and record traffic characteristics with respect to bearers that may carry unlicensed spectrum traffic. The traffic measurement may be performed for each individual bearer and may be performed separately for uplink and downlink.

In some embodiments, an operator may designate bearers as exclusively for unlicensed spectrum or exclusively for licensed spectrum. For example, the RAT type of each bearer may be configured at the eNB. The eNB may then measure a usage of individual bearers and record that usage, along with an associated RAT type in some embodiments, in the traffic measurement. The final charging per UE/bearer may be completed based on the authorized RAT type of each bearer.

In some embodiments, usage of licensed/unlicensed RAT may be more dynamic than the previous example, and may even allow for simultaneous use of both RATs. Various embodiments may include different processes for performing a traffic measurement at 504 configured for online and offline charging processes.

For offline or online charging, the eNB may record the usage across both types of spectrum in the charging information.

At 508, the reporting procedure 500 may include an eNB, or the collection circuitry within the eNB, in particular, detecting a reporting trigger. The reporting trigger may be a periodic or event-based based trigger. In some embodiments, the reporting trigger may be a change in a specific bearer configuration. For example, a bearer that is exclusively configured for unlicensed spectrum traffic may be reconfigured for licensed spectrum traffic or a mix of unlicensed and licensed spectrum traffic. At the time of such a reconfiguration, it may be desirable to report a measure of traffic pertaining to the period in which the bearer was exclusively configured for unlicensed spectrum traffic.

In some embodiments, the reporting trigger may relate to a conclusion of a communication session. This may be, for example, at a radio resource control (RRC) connection release; when a UE transitions into an idle mode; performs a handover; etc.

In some embodiments, the reporting trigger may relate to predetermined usage limits based on traffic volume or time. For example, for online charging, an authorization may either be directly negotiated by the eNB or configured at the eNB by S-GW/P-GW based on negotiated limits. In such instances, per-RAT usage limits may be set so that charging reports or quotas do not need to be negotiated in real-time. The eNB may detect a reporting trigger when these usage limits are met.

The network may further configure a scheduling priority for the eNB to tailor its scheduling policy in light of usage limits. For example, since an operator may charge differently for licensed and unlicensed usage, the operator may configure a policy at the eNB so that the eNB schedules a user over a band where it is likely to cost less. For example, if usage of unlicensed spectrum is free, then the policy configured at the eNB may prioritize scheduling of the UE over unlicensed spectrum before licensed spectrum.

At 512, the reporting procedure 500 may include the eNB, or the collection/signaling circuitry within the eNB, generating a report. The generating of the report may be in response to the detecting of the reporting trigger 508 and may be based on, for example, information related to the traffic measurement performed at 504.

At 516, the reporting procedure 500 may include transmission of the traffic report. The report may be transmitted via transceiver circuitry of the eNB to CDF/OCS. In some embodiments, for example, in the charging architecture 100, the report may be transmitted directly to the CDF/OCS. In other embodiments, for example, in charging architectures 200 or 300, the report may be transmitted through one or more intervening network elements. The intervening network elements may include an MME, an S-GW, or a P-GW.

At 520, the reporting procedure 500 may include a CDF/OCS generating a CDR report. The CDR report may include a CDR file that is generated with charging information from the traffic report. A single CDR file may be constructed to include charging information related to a single charging event or multiple charging events. The content and format of CDR files may be similar to those described in, for example, 3GPP TS 32.250 v12.3.0 (2014-12).

At 524, the reporting procedure 500 may include transmitting the CDR report from the CDF/OCS to a billing domain.

At 528, the reporting procedure 500 may include differentiated charging and user data monitoring by the billing domain. The billing domain may receive and process the CDR files from the CDF/OCS to provide the differentiated charging for usage of the licensed/unlicensed spectrum. In this manner, an operator may be able to appropriately account for opportunistic, real-time use of unlicensed spectrum within an access network, whether through WLAN/LTE aggregation or LTE-U/LAA, on a per-bearer/per-user basis. Furthermore, providing the processes and architectures shown herein may allow for this accounting to be performed without excessive signaling within a network.

In various embodiments, different operations of the reporting procedure 500 may be performed by entities other than those shown with respect to FIG. 5. For example, in some embodiments some or all of the differentiated charging and user data monitoring may be performed by network entities other than the billing domain, such as by the OCS.

In some embodiments, the operations described herein may be performed by a particular device as a result of one or more processors executing instructions stored on one or more non-transitory, computer-readable media (for example, memory/storage 406 of FIG. 4).

Some non-limiting examples are provided below.

Example 1 includes an apparatus to be employed in an evolved node B (eNB), the apparatus comprising: collection circuitry to collect information about licensed and unlicensed spectrum resource usage for individual bearers of a plurality of bearers that provide access to a cellular network using one or more radio access technologies (RATs); and signaling circuitry, coupled with the collection circuitry, to transmit the collected information to a network node in a core network.

Example 2 includes the apparatus of example 1, wherein the network node is a charging data function (CDF) and the signaling circuitry is to transmit the collected information to the CDF for offline charging.

Example 3 includes the apparatus of example 2, wherein the signaling circuitry is to transmit the collected information to the CDF via an Rf interface.

Example 4 includes the apparatus of example 1, wherein the network node is an online charging system (OCS) and the signaling circuitry is to transmit the collected information to the OCS for online charging.

Example 5 includes the apparatus of example 4, wherein the signaling circuitry is to transmit the collected information to the OCS via a Gy′ or Ro′ interface.

Example 6 includes the apparatus of any of examples 1-5, wherein the collection circuitry is to collect information about licensed and unlicensed spectrum resource usage related to one or more evolved packet system (EPS) bearers in a wireless network and the signaling circuitry is to transmit information about the one or more EPS bearers to the network node.

Example 7 includes the apparatus of example 1, wherein the network node is a serving gateway (S-GW) and the signaling circuitry is to transmit the collected information to the S-GW via an S1 interface.

Example 8 includes the apparatus of example 1, wherein the network node is a mobility management entity (MME) and the signaling circuitry is to transmit the collected information to the MME via an S1-MME interface.

Example 9 includes one or more non-transitory, computer-readable media having instructions that, when executed, cause an evolved node B (eNB) to: collect information related to licensed and unlicensed spectrum resource usage related to one or more bearers in a wireless network; detect a trigger event; and transmit an indication of the collected information related to the spectrum resource usage to a network node of the wireless network based on said detecting of the trigger event.

Example 10 includes the one or more non-transitory, computer-readable media of example 9, wherein the one or more bearers are one or more evolved packet system (EPS) bearers and the instructions, when executed, further cause the eNB to transmit information about the one or more EPS bearers to the network node.

Example 11 includes the one or more non-transitory, computer-readable media of any one of examples 9-10, wherein the collected information is related to licensed and unlicensed spectrum resource usage related to respective bearers of the one or more bearers.

Example 12 includes the one or more non-transitory, computer-readable media of any one of examples 9-11, wherein the network node is a charging data function (CDF) to use the information for offline charging; or an online charging system (OCS) to use the information for charging that occurs concurrently with usage of one of the one or more bearers.

Example 13 includes the one or more non-transitory, computer-readable media of any one of examples 9-11, wherein the network node is a serving gateway (S-GW) and the instructions, when executed, further cause the eNB to transmit the indication to the S-GW via an S1 interface; or the network node is an online charging system (OCS) and the indication includes an authorization request related to licensed or unlicensed spectrum usage.

Example 14 includes the one or more non-transitory, computer-readable media of any one of claims 9-11, wherein the network node is a mobility management entity (MME) and the instructions, when executed, further cause the eNB to transmit the indication to the MME via an S1-MME interface.

Example 15 includes the one or more non-transitory, computer-readable media of any one of claims 9-14, wherein the indication includes a report to characteristics of traffic offloaded to resources in an unlicensed spectrum.

Example 16 includes the one or more non-transitory, computer-readable media of example 15, wherein the report includes, for respective bearers with traffic offloaded to resources in the unlicensed spectrum, a bearer identifier, a bearer offload time, a downlink bearer offload volume, or an uplink bearer offload volume.

Example 17 includes the one or more non-transitory, computer-readable media of any one of examples 9-16, wherein the trigger event is a radio resource control (RRC) connection release.

Example 18 includes an apparatus comprising: receive circuitry to receive, from an evolved NodeB (eNB), information related to licensed spectrum resource usage and unlicensed spectrum resource usage related to one or more evolved packet switched (EPS) bearers in a wireless network; and control circuitry coupled with the receive circuitry, the control circuitry to perform one or more charging related functions based on the information.

Example 19 includes the apparatus of example 18, wherein the apparatus is to be employed in a serving gateway and the receive circuitry is to receive the information, from the eNB, via an S1 interface, or receive the information, from a mobility management entity (MME), via an S11 interface.

Example 20 includes the apparatus of example 18, wherein the apparatus is to be employed in a charging data function and the receive circuitry is to receive the information via an Rf interface from the eNB or via an Rf interface from a serving gateway or a packet gateway.

Example 21 includes the apparatus of example 18, wherein the apparatus is to be employed in an online charging system and the receive circuitry is to receive the information via an Ro′ or Gy′ interface from the eNB or via a Gy interface from a packet gateway.

Example 22 includes the apparatus of example 20 or 21, wherein the one or more charging related functions comprise generating a charging data record (CDR) and transmitting the CDR to a billing domain.

Example 23 includes the apparatus of example 18, wherein the apparatus is to be employed by a packet gateway and the receive circuitry is to receive the information, from a serving gateway, via an S5 or S8 interface.

Example 24 includes the apparatus of example 18, wherein the apparatus to be employed in a mobility management entity (MME) and the receive circuitry is to receive the information via an S1-MME interface.

Example 25 includes the apparatus of example 23 or 24, wherein the one or more charging related functions comprise transmitting at least part of the information to a charging data function or an online charging system.

Example 26 includes a method comprising: selecting information about licensed and unlicensed spectrum resource usage for individual bearers of a plurality of bearers that provide access to a cellular network using one or more radio access technologies (RATs); and transmitting the collected information to a network node in a core network.

Example 27 includes the method of example 26, wherein the network node is a charging data function (CDF) and the method further comprises transmitting the collected information to the CDF for offline charging.

Example 28 includes the method of example 27, further comprising transmitting the collected information to the CDF via an Rf′ interface.

Example 29 includes the method of any one of examples 26-28, wherein the network node is an online charging system (OCS) and the method further comprises transmitting the collected information to the OCS for online charging.

Example 30 includes the method of example 29, further comprising transmitting the collected information to the OCS via a Gy′ or Ro′ interface.

Example 31 includes the method of any one of examples 26-30, further comprising collecting information about licensed and unlicensed spectrum resource usage related to one or more evolved packet system (EPS) bearers in a wireless network and transmitting information about the one or more EPS bearers to the network node.

Example 32 includes the method of any one of examples 26-31, wherein the network node is a serving gateway (S-GW) and the method further comprises transmitting the collected information to the S-GW via an S1 interface.

Example 33 includes the method of any one of examples 26-32, wherein the network node is a mobility management entity (MME) and the method further comprises transmitting the collected information to the MME via an S1-MME interface.

Example 34 includes a method comprising: collecting information related to licensed and unlicensed spectrum resource usage related to one or more bearers in a wireless network; detecting a trigger event; and transmitting an indication of the collected information related to the spectrum resource usage to a network node of the wireless network based on said detecting of the trigger event.

Example 35 includes the method of example 34, wherein the one or more bearers are one or more evolved packet system (EPS) bearers and the method further comprises transmitting information about the one or more EPS bearers to the network node.

Example 36 includes the method of any one of examples 34 or 35, wherein the collected information is related to licensed and unlicensed spectrum resource usage related to respective bearers of the one or more bearers.

Example 37 includes the method of any one of examples 34-36, wherein the network node is a charging data function (CDF) to use the information for offline charging; or an online charging system (OCS) to use the information for charging that occurs concurrently with usage of one of the one or more bearers.

Example 38 includes the method of any one of examples 34-37, wherein the network node is a serving gateway (S-GW) and the method further comprises transmitting the indication to the S-GW via an S1 interface; or the network node is an online charging system (OCS) and the indication includes an authorization request related to licensed or unlicensed spectrum usage.

Example 39 includes the method of any one of examples 34-38, wherein the network node is a mobility management entity (MME) and the further comprises transmitting the indication to the MME via an S1-MME interface.

Example 40 includes the method of any one of examples 34-39, wherein the indication includes a report to characteristics of traffic offloaded to resources in an unlicensed spectrum.

Example 41 includes the method of example 40, wherein the report includes, for respective bearers with traffic offloaded to resources in the unlicensed spectrum, a bearer identifier, a bearer offload time, a downlink bearer offload volume, or an uplink bearer offload volume.

Example 42 includes the method of any one of examples 34-41, wherein the trigger event is a radio resource control (RRC) connection release.

Example 43 includes a method comprising: receiving, from an evolved NodeB (eNB), information related to licensed spectrum resource usage and unlicensed spectrum resource usage related to one or more evolved packet switched (EPS) bearers in a wireless network; and performing one or more charging related functions based on the information.

Example 44 includes the method of example 43, wherein the method is to be performed by a serving gateway and the method further comprises receiving the information, from the eNB, via an S1 interface, or receiving the information, from a mobility management entity (MME), via an S11 interface.

Example 45 includes the method of example 43, wherein the method is to be performed by a charging data function and the method further comprises receiving the information via an Rf′ interface from the eNB or via an Rf interface from a serving gateway or a packet gateway.

Example 46 includes the method of example 43, wherein the method is to be performed by an online charging system and the method further comprises receiving the information via an Ro′ or Gy′ interface from the eNB or via a Gy interface from a packet gateway.

Example 47 includes the method of example 45 or 46, wherein the one or more charging related functions comprise generating a charging data record (CDR) and transmitting the CDR to a billing domain.

Example 48 includes the method of example 43, wherein the method is to be performed by a packet gateway and the method further comprises receiving the information, from a serving gateway, via an S5 or S8 interface.

Example 49 includes the method of example 43, wherein the method is to be performed by a mobility management entity (MME) and the method further comprises receiving the information via an S1-MME interface.

Example 50 includes the method of example 48 or 49, wherein the one or more charging related functions comprise transmitting at least part of the information to a charging data function or an online charging system.

Example 51 includes an apparatus comprising means to perform any one of the methods of examples 26-50.

Example 52 includes one or more non-transitory, computer-readable media having instructions that, when executed, perform any one of the methods of examples 26-33 and 43-50.

Example 53 includes an evolved NodeB (eNB) comprising: control circuitry to identify information related to licensed spectrum resource usage and unlicensed spectrum resource usage related to one or more evolved packet switched (EPS) bearers in a wireless network; and transmit circuitry coupled with the control circuitry, the transmit circuitry to transmit an indication of the information related to the licensed and/or unlicensed spectrum usage to a network node of the wireless network.

Example 54 includes the eNB of 53, wherein the control circuitry is further to identify the information related to the licensed or unlicensed spectrum resource usage related to respective EPS bearers of the one or more EPS bearers.

Example 55 includes the eNB of example 53 are 54, wherein the network node is a charging data function (CDF) to use the information for offline charging.

Example 56 includes the eNB of example 53 are 54, wherein the network node is an online charging function (OCF) to use the information for charging that occurs concurrently with usage of one of the one or more bearers.

Example 57 includes the eNB of any one of examples 53-56, wherein the indication includes information related to the one or more bearers.

Example 58 includes the eNB of example 53 or 54, wherein the network node is a serving gateway (S-GW), and the transmit circuitry is further to transmit the indication to the S-GW via a S1 interface.

Example 59 includes the eNB of any one of examples 53-58, wherein the indication includes an authorization request related to licensed and/or unlicensed spectrum usage.

Example 60 includes the eNB of example 53 or 54, wherein the network node is a mobility management entity (MME), and the transmit circuitry is further to transmit the indication to the MME via a S1-MME interface.

Example 61 includes the eNB of any one of examples 53-60, wherein the indication includes an offload traffic report related to the unlicensed band.

Example 62 includes the eNB of example 61, wherein the offload traffic report includes a number of active bearers with traffic offloaded to a resource in the unlicensed spectrum.

Example 63 includes the eNB of any one of examples 53-62, wherein the indication further includes, for respective bearers with traffic offloaded to the resource in the unlicensed spectrum, a bearer identifier, a bearer offload time, a downlink bearer offload volume, and/or an uplink bearer offload volume.

Example 64 includes the eNB of any one of examples 61-62, wherein the report is triggered by radio resource control (RRC) connection release.

Example 65 includes a serving gateway (S-GW) comprising: receive circuitry to receive, from an evolved NodeB (eNB), information related to licensed spectrum resource usage and unlicensed spectrum resource usage related to one or more evolved packet switched (EPS) bearers in a wireless network; and control circuitry coupled with the receive circuitry, the control circuitry to perform one or more charging related functions based on the information.

Example 66 includes the S-GW of example 65, wherein the receive circuitry is further to receive the information related to the licensed or unlicensed spectrum resource usage related to respective bearers of the one or more bearers.

Example 67 includes the S-GW of example 65 or 66, wherein the indication includes information related to the one or more bearers.

Example 68 includes the S-GW of any one of examples 65-67, wherein the receive circuitry is to receive the information via a S1 interface.

Example 69 includes the S-GW of any one of examples 65-68, wherein the indication includes an authorization request related to licensed and/or unlicensed spectrum usage.

Example 70 includes the S-GW of any one of examples 65-69, wherein the one or more charging related functions includes facilitation by the control circuitry of transmission, by transmit circuitry of the S-GW, at least a portion of the information to a charging data function (CDF) or a packet gateway (P-GW).

Example 71 includes a mobility management entity (MME) comprising: receive circuitry to receive, from an evolved NodeB (eNB), information related to licensed spectrum resource usage and unlicensed spectrum resource usage related to one or more evolved packet switched (EPS) bearers in a wireless network; and control circuitry coupled with the receive circuitry, the control circuitry to perform one or more charging related functions based on the information.

Example 72 includes the MME of example 71, wherein the receive circuitry is further to receive the information related to the licensed or unlicensed spectrum resource usage related to respective bearers of the one or more bearers.

Example 73 includes the MME of example 71 or 72, wherein the indication includes information related to the one or more bearers.

Example 74 includes the MME of any one of example 71-73, wherein the receive circuitry is to receive the information via a S1-MME interface.

Example 75 includes the MME of any one of examples 71-74, wherein the indication includes an authorization request related to licensed and/or unlicensed spectrum usage.

Example 76 includes the MME of any one of examples 71-75, wherein the indication includes an offload traffic report related to the unlicensed band.

Example 77 includes the MME of any one of examples 71-76, wherein the report includes a number of active bearers with traffic offloaded to a resource in the unlicensed spectrum.

Example 78 includes the MME of any one of examples 71-77, wherein the indication further includes, for respective bearers with traffic offloaded to the resource in the unlicensed spectrum, a bearer identifier, a bearer offload time, a downlink bearer offload volume, and/or an uplink bearer offload volume.

Example 79 includes the MME of any one of examples 71-78, wherein the report is triggered by radio resource control (RRC) connection release.

Example 80 includes the MME of any one of examples 71-79, wherein the one or more charging related functions includes facilitation, by the control circuitry, of transmission by transmit circuitry of the MME of the offload traffic report to a serving gateway (S-GW) via a S11 interface.

The description herein of illustrated implementations, including what is described in the Abstract, is not intended to be exhaustive or to limit the present disclosure to the precise forms disclosed. While specific implementations and examples are described herein for illustrative purposes, various equivalent modifications are possible within the scope of the disclosure, as those skilled in the relevant art will recognize. These modifications may be made to the disclosure in light of the above detailed description.

1. An apparatus to be employed in an evolved node B (eNB), the apparatus comprising:
collection circuitry to collect information about licensed and unlicensed spectrum resource usage for individual bearers of a plurality of bearers that provide access to a cellular network using one or more radio access technologies (RATs); and
signaling circuitry, coupled with the collection circuitry, to transmit the collected information to a network node in a core network.

2. The apparatus of claim 1, wherein the network node is a charging data function (CDF) and the signaling circuitry is to transmit the collected information to the CDF for offline charging.

3. The apparatus of claim 2, wherein the signaling circuitry is to transmit the collected information to the CDF via an Rf′ interface.

4. The apparatus of claim 1, wherein the network node is an online charging system (OCS) and the signaling circuitry is to transmit the collected information to the OCS for online charging.

5. The apparatus of claim 4, wherein the signaling circuitry is to transmit the collected information to the OCS via a Gy′ or Ro′ interface.

6. The apparatus of claim 1, wherein the collection circuitry is to collect information about licensed and unlicensed spectrum resource usage related to one or more evolved packet system (EPS) bearers in a wireless network and the signaling circuitry is to transmit information about the one or more EPS bearers to the network node.

7. The apparatus of claim 1, wherein the network node is a serving gateway (S-GW) and the signaling circuitry is to transmit the collected information to the S-GW via an Si interface.

8. The apparatus of claim 1, wherein the network node is a mobility management entity (MME) and the signaling circuitry is to transmit the collected information to the MME via an S1-MME interface.

9. One or more non-transitory, computer-readable media having instructions that, when executed, cause an evolved node B (eNB) to:
collect information related to licensed and unlicensed spectrum resource usage related to one or more bearers in a wireless network;
detect a trigger event; and
transmit an indication of the collected information related to the spectrum resource usage to a network node of the wireless network based on said detecting of the trigger event.

10. The one or more non-transitory, computer-readable media of claim 9, wherein the one or more bearers are one or more evolved packet system (EPS) bearers and the instructions, when executed, further cause the eNB to transmit information about the one or more EPS bearers to the network node.

11. The one or more non-transitory, computer-readable media of claim 9, wherein the collected information is related to licensed and unlicensed spectrum resource usage related to respective bearers of the one or more bearers.

12. The one or more non-transitory, computer-readable media of claim 9, wherein the network node is a charging data function (CDF) to use the information for offline charging; or an online charging system (OCS) to use the information for charging that occurs concurrently with usage of one of the one or more bearers.

13. The one or more non-transitory, computer-readable media of claim 9, wherein the network node is a serving gateway (S-GW) and the instructions, when executed, further cause the eNB to transmit the indication to the S-GW via an S1 interface; or the network node is an online charging system (OCS) and the indication includes an authorization request related to licensed or unlicensed spectrum usage.

14. The one or more non-transitory, computer-readable media of claim 9, wherein the network node is a mobility management entity (MME) and the instructions, when executed, further cause the eNB to transmit the indication to the MME via an S1-MME interface.

15. The one or more non-transitory, computer-readable media of claim 9, wherein the indication includes a report to characteristics of traffic offloaded to resources in an unlicensed spectrum.

16. The one or more non-transitory, computer-readable media of claim 15, wherein the report includes, for respective bearers with traffic offloaded to resources in the unlicensed spectrum, a bearer identifier, a bearer offload time, a downlink bearer offload volume, or an uplink bearer offload volume.

17. The one or more non-transitory, computer-readable media of claim 9, wherein the trigger event is a radio resource control (RRC) connection release.

18. An apparatus comprising:
receive circuitry to receive, from an evolved NodeB (eNB), information related to licensed spectrum resource usage and unlicensed spectrum resource usage related to one or more evolved packet switched (EPS) bearers in a wireless network; and
control circuitry coupled with the receive circuitry, the control circuitry to perform one or more charging related functions based on the information.

19. The apparatus of claim 18, wherein the apparatus is to be employed in a serving gateway and the receive circuitry is to receive the information, from the eNB, via an S1 interface, or receive the information, from a mobility management entity (MME), via an S11 interface.

20. The apparatus of claim 18, wherein the apparatus is to be employed in a charging data function and the receive circuitry is to receive the information via an Rf′ interface from the eNB or via an Rf′ interface from a serving gateway or a packet gateway.

21. The apparatus of claim 18, wherein the apparatus is to be employed in an online charging system and the receive circuitry is to receive the information via an Ro′ or Gy′ interface from the eNB or via a Gy interface from a packet gateway.

22. The apparatus of claim 20, wherein the one or more charging related functions comprise generating a charging data record (CDR) and transmitting the CDR to a billing domain.

23. The apparatus of claim 18, wherein the apparatus is to be employed by a packet gateway and the receive circuitry is to receive the information, from a serving gateway, via an S5 or S8 interface.

24. The apparatus of claim 18, wherein the apparatus to be employed in a mobility management entity (MME) and the receive circuitry is to receive the information via an S1-MME interface.

25. The apparatus of claim 23 or 211, wherein the one or more charging related functions comprise transmitting at least part of the information to a charging data function or an online charging system.
